(19) United States
(12) Patent Application Publication
(10) Pub. No.: US 2014/0289137 A1
(43) Pub. Date: Sep. 25, 2014

(54) COMPUTER SYSTEM FOR INSTRUCTING AN INTELLECTUAL PROPERTY (IP) FILING

(71) Applicant: INOVIA HOLDINGS PTY LTD, Sydney, New South Wales (AU)

(72) Inventors: Justin Ryan Simpson, Sydney (AU); John Wilfred Adaikalam Selvaraj, Sydney (AU)

(21) Appl. No.: 14/354,847

(22) PCT Filed: Oct. 26, 2012
(86) PCT No.: PCT/AU2012/001307

§ 371 Date: Apr. 28, 2014

(30) Foreign Application Priority Data
Oct. 26, 2011 (AU) 2011904442

(51) Int. Cl. G06Q 50/18; G06Q 10/10

(52) U.S. Cl. CPC G06Q 50/184; G06Q 10/10
USPC 705/310

(57) ABSTRACT

A computer systems for instructing an intellectual property (IP) filing, in particular, to a computer-implemented system for automatically updating the status of an IP record in an IP database by clicking on an encoded URL.

### FIELD OF THE INVENTION

The present invention relates to a computer system for instructing an intellectual property (IP) filing.

The invention has been developed specifically for the filing of foreign patent applications and will be described below with reference to that application. However, it will be appreciated that it is not limited to that particular use, and is also suitable for the instruction of other types of intellectual property processes.

### DISCUSSION OF THE PRIOR ART

When instructing the filing of a patent into, say, six foreign countries, the following steps (at a minimum) will normally need to be performed:
Step 1: The instructor first creates a record for each country in his/her IP management system (often called “docketing systems”).
Step 2: The instructor then creates bundles of instructions and sends them to each of the foreign associates (here called “receiving agents”).
Step 3: Once each of the receiving agents receives the instructions they then create their own records of the case in their own docketing systems.
Step 4: The receiving agent sends a message to the instructor acknowledging receipt of the instructions.
Step 5: The instructor updates the status of the case in his/her docketing system to confirm that the instructions have been received.
Step 6: Once the case has been filed, the receiving agent updates the status of the case in his/her docketing system to confirm that the case has been filed.
Step 7: The receiving agent then sends a message to the instructor to confirm that the case has been filed.
Step 8: The instructor then updates the status of the case in his/her docketing system to confirm that the case has been filed.

In the above exchange for a filing into six countries, there will have been a bare minimum of 18 messages exchanged and 36 status updates logged in docketing systems (18 by the instructor and 18 by the 6 receiving agents). A filing into 20 or 30 countries simultaneously would result in an exponential number of emails and status updates having to be manually processed.

This example illustrates the very large amount of communication traffic involved in instructing a foreign patent filing, along with the large amount of duplicated status updates required by every instructor and every receiving agent in the process.

Any discussion of the background art throughout the specification should in no way be considered as an admission that such art is widely known or forms part of common general knowledge in the field.

It is an object of the present invention to overcome or ameliorate at least one of the disadvantages of the prior art or to provide a useful alternative.

### DISCLOSURE OF THE INVENTION

According to a first aspect of the present invention there is disclosed a computer system for instructing an intellectual property (IP) filing including an instruction tool adapted to communicate with an IP order database,

the IP order database being adapted to store a plurality of IP order records, each including:
(a) at least one receiving agent email address; and
(b) an updatable status,

the instruction tool being adapted to send an email containing a URL corresponding to a particular IP order record, to a corresponding receiving agent email address.

Preferably, wherein when the encoded URL is activated the system updates the updatable status corresponding to the particular IP order record.

According to a second aspect of the present invention there is disclosed a URL which, when activated, automatically modifies the status of an updatable status field of a particular IP order record stored in an IP order database.

According to a third aspect of the present invention there is disclosed an intellectual property docketing system including an IP order database and a web services response processor,

the IP order database being adapted to store a plurality of IP order records, each including an updatable status, and

the web services response processor being adapted to update the updatable status of at least one IP order record in response to receiving a web services response.

Preferably, the web services response comprises an XML file containing at least the following information:
(a) in IP order identifier; and
(b) a status update indicator.

According to a fourth aspect of the present invention there is disclosed a web services response comprising an XML file containing at least the following information:
(a) in IP order identifier; and
(b) a status update indicator.

According to a fifth aspect of the present invention there is disclosed a method for instructing an intellectual property (IP) filing including:

providing an instruction tool adapted to communicate with an IP order database,

configuring the IP order database to store a plurality of IP order records, each including:
(a) at least one receiving agent email address; and
(b) an updatable status, and

configuring the instruction tool to send an email containing a URL corresponding to a particular IP order record, to a corresponding receiving agent email address.

According to a sixth aspect of the present invention there is disclosed an intellectual property docketing method including:

providing an IP order database and a web services response processor,

configuring the IP order database to store a plurality of IP order records, each including an updatable status, and

configuring the web services response processor to update the updatable status of at least one IP order record in response to receiving a web services response.

According to a seventh aspect of the present invention there is disclosed a computer system for receiving instructions for an intellectual property (IP) filing including an instruction receiving tool adapted to communicate with an IP order database,

the IP order database being adapted to store a plurality of IP order records, each including:
(a) at least one receiving agent email address; and
(b) an updatable status,

the instruction receiving tool being adapted to receive an email containing a URL corresponding to a particular IP order record, from a corresponding sending agent email address.

### BRIEF DESCRIPTION OF THE DRAWINGS

The preferred embodiments will now be described, by way of example only, with reference to the accompanying drawings in which:

FIG. 1 is a block diagram of a computer system, according to an embodiment of the invention.

FIG. 2 is a block diagram of a computer system, according to a further embodiment of the invention.

### DETAILED DESCRIPTION

In the description and claims use is made of the term “country” to indicate a jurisdiction to which an intellectual property right, or an application for an intellectual property right, pertains. It will be appreciated that, unless the context clearly indicates otherwise, this term country is intended to also cover “region” or multiple countries if such an intellectual property has a nature which extends or applies to such a region or countries.

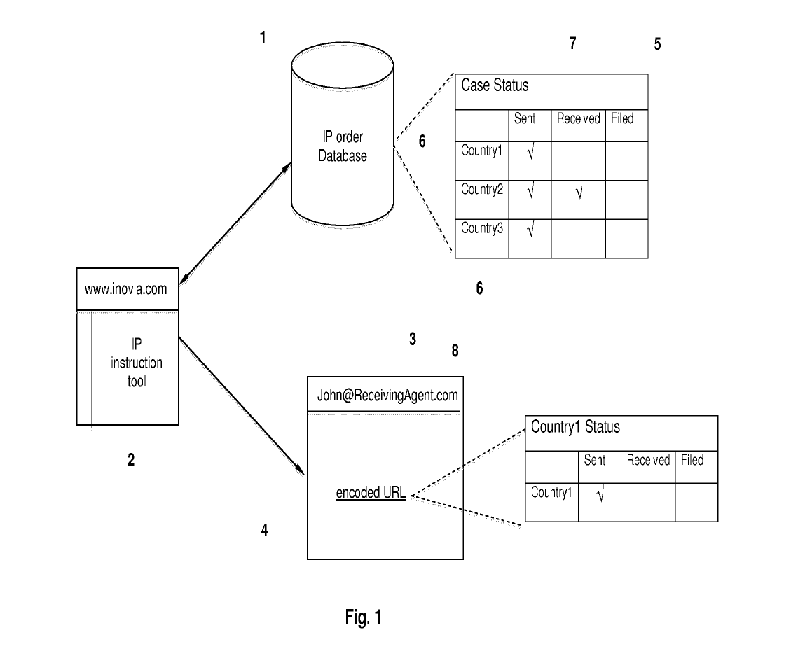

Referring to FIG. 1, there is shown a first embodiment of a computer system for instructing an intellectual property (IP) filing. The computer system includes an IP order database 1 storing a plurality of order records 5. The order records relate to an order for the foreign filing of a piece of intellectual property, such as a patent, into a plurality of foreign countries. For each country record 6 there are a plurality of stages 7 that indicate the status of the filing. In this embodiment, the stage “sent” indicates that the instructing attorney has sent the instructions to the foreign receiving agent. The stage “received” means that the receiving agent has confirmed safe receipt of the instructions. The stage “filed” means that the patent application has been filed by the receiving agent with their local patent office.

An instruction tool 2 is adapted to communicate with the IP order database. The instruction tool is adapted to send an instruction email 3 to at least one foreign receiving agent email address 8.

The instructing email 3 is adapted to include an encoded URL 4 which, when activated by a receiving agent user automatically updates the stage 7 corresponding to:
(a) a particular order;
(b) a particular country; and
(c) a particular stage.

For example, by clicking the URL, the stage 7 of the Country 3 record in the IP order database 1 is updated from “sent” to “received.” A variety of other stages are also envisaged, some of which correspond to steps taken by the instructor and others taken by the receiving agent. A non-exhaustive list is as follows:
i. Ordered
ii. Ready to proceed
iii. Instructed Agent
iv. Instruction verified
v. Agent received
vi. Agent Filed
vii. Translation Filed
viii. All done verified
ix. Cancelled

In this way, with one click, a receiving agent can confirm safe receipt of instructions from the instructor and the IP order database can be updated automatically.

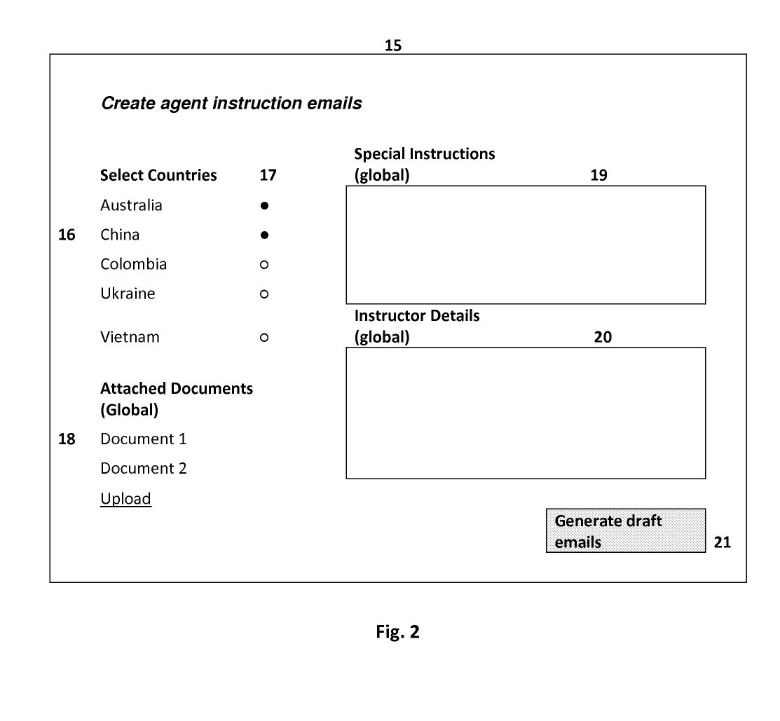

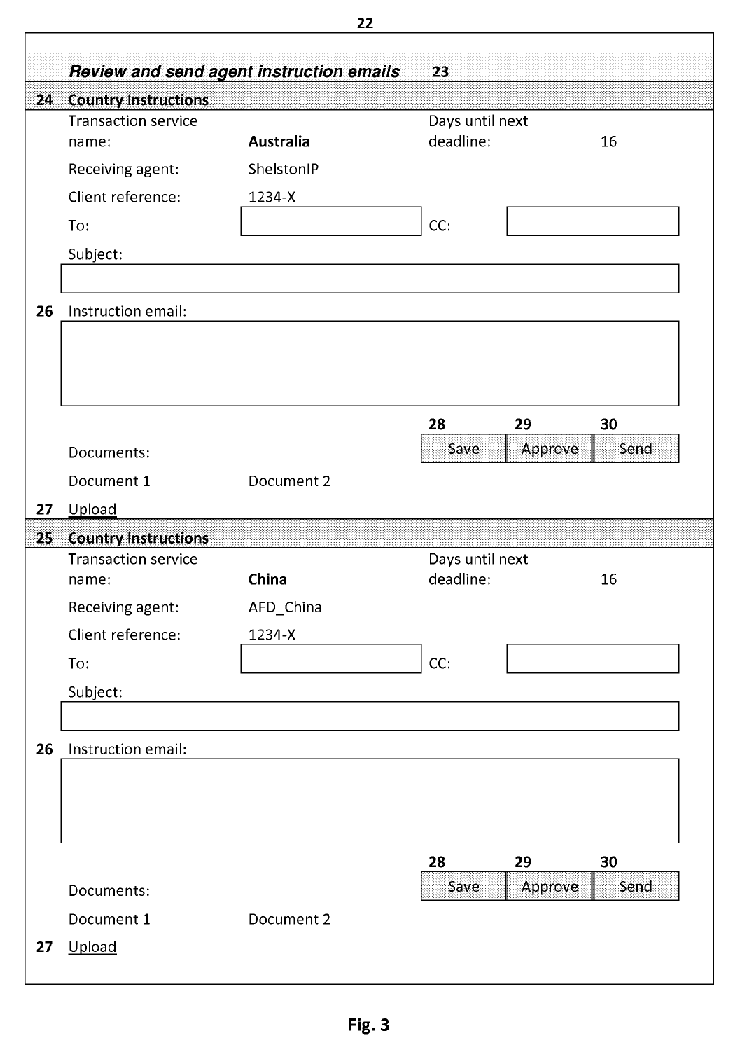

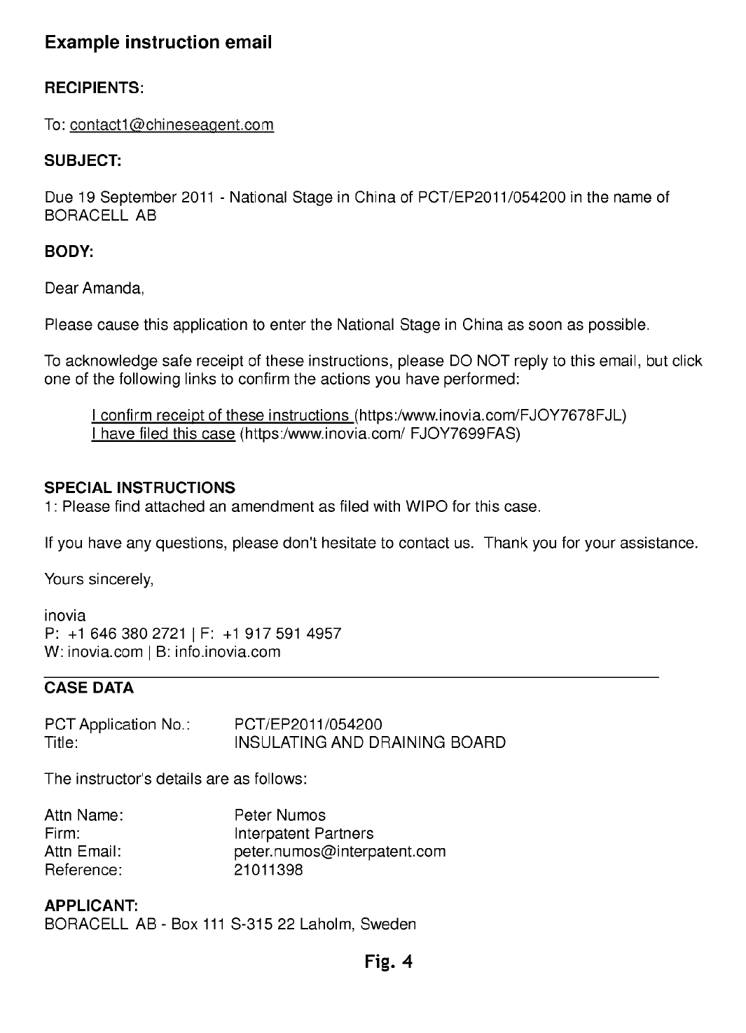

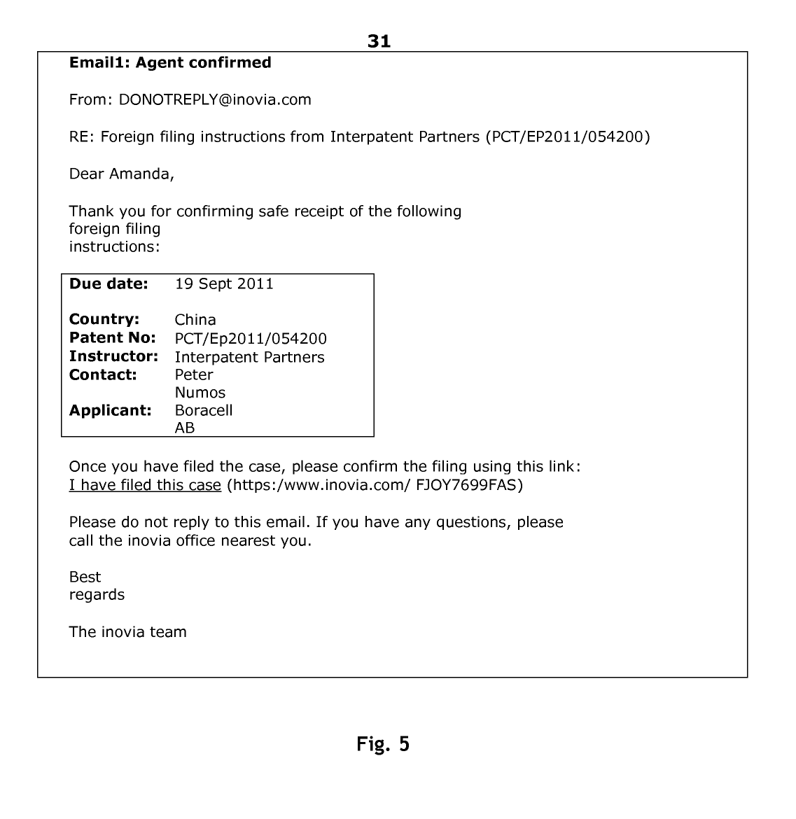

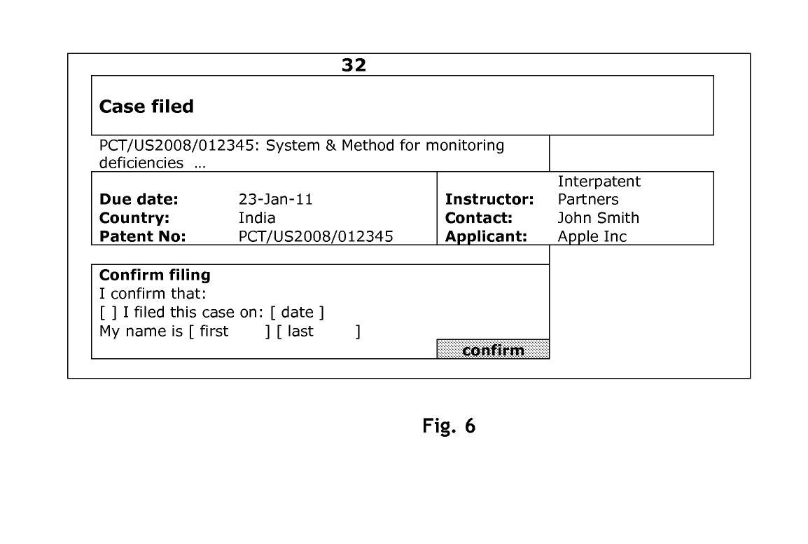

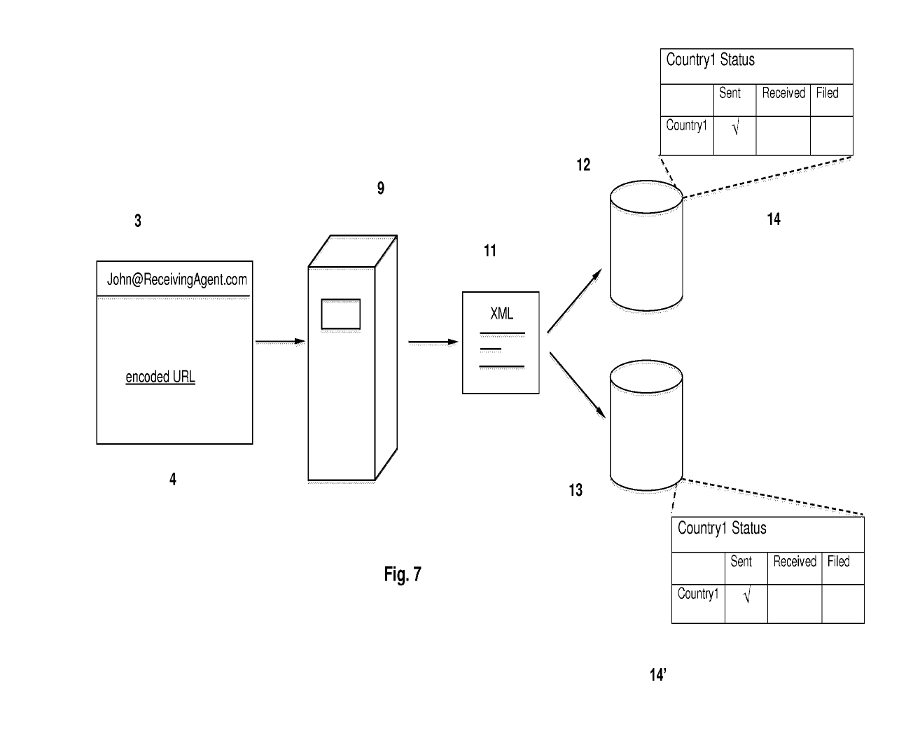

An example instruction tool 2 is described below with reference to FIGS. 2 and 3 below.

Turning to FIG. 2, the instruction tool 2 includes a global instruction interface 15. The interface 15 contains a country list 16 corresponding to the country records 6 in a particular order 5. In this example, five countries have been chosen and the instruction tool 2 is adapted to generate emails instructing the national phase entry into those five countries. A set of radio buttons 17 adjacent the country list 16 allows the user to generate instruction emails for some or all countries simultaneously. The interface includes a document attachment section 18 adapted to allow the upload of documents needed by the receiving agent, such as the specification or the IPRP.

The global special instructions section 19 provides the ability to insert text which will accompany instructions to all the receiving agents. The instructor details section 20 is preferably populated from the IP order database and contains contact details of the person(s) with whom the receiving agent should communicate after the filing.

Upon clicking the “Generate draft emails” button 21, the user is presented with the specific instruction interface 22 shown in FIG. 3. This interface 22 includes a plurality of country-specific sections 23, each relating to one of the countries selected on the global instruction interface 15. In this example, Australia and China were selected in FIG. 2 so there is an Australia section 24 and a China section 25.

In each of the country-specific sections 23 the instruction tool 2 populates the various fields with appropriate information for that country. For example, the PCT application number will be universal to all sets of instructions, but the country listed in the subject will differ for each country. The instruction email section 26 not only contains information from the global special instruction section 19, but also allows the user to input instructions specific to that country. For example, the user may wish to amend the claims in China and would include instructions to that effect in the instruction email section 26 and would attach the amended claims in the country-specific document upload section 27.

The save button 28 allows the user to save the information for later editing. The Approve button 29 allows a supervisor to review and approve draft instructions to confirm they are ready for sending. The send button 30 generates and sends instruction emails 3 to each of the receiving agent email addresses 8.

An example instruction email 3 is shown in FIG. 4. Importantly, the instruction email contains, in this example, two encoded URLs 4′ and 4.″ In this example, whilst the recipient sees the words “I confirm receipt of these instructions”, when they click the link the encoded URL 4′ https:/www.inovia.com/FJOY7678FJL is activated. By clicking that link, the system automatically updates the status of the corresponding order record 5 in the IP order database 1 to the status “Received”. In this way, the receiving agent is able to click a single link to acknowledge safe receipt of the IP instructions, rather than drafting an emailed reply.

Similarly, when the receiving agent has filed the case, they can click on the second encoded URL 4″ by clicking the link they see as “I have filed this case”. When they click that link, the encoded URL 4″ https:/www.inovia.com/FJOY7699FAS is activated. By clicking that link, the system automatically updates the status of the corresponding order record 5 in the IP order database 1 to the status “Filed”.

Preferably, the IP instruction tool, in response to the activation of any encoded URL 4, sends a confirmation email 31 to the receiving agent email address 8. An example of such confirmation email appears in FIG. 5. Note that in this preferred embodiment, the system acknowledges the status that has just been changed and provides a further encoded URL 4″ corresponding to the next stage in the filing process that needs completing. Preferably a similar email is not sent to the instructing user, as part of the aim of this invention is to cut down email traffic returning from foreign patent agents. Most foreign patent agents, however, like to receive such confirmations for their files.

It will be understood by persons skilled in the art that the above instruction tool allows the streamlined creation of multiple instruction emails to multiple foreign attorneys simultaneously. Not only are the emails automatically populated with relevant bibliographic information, but they importantly contain encoded URLs which, once activated, allow the automatic updating of the order database 1 without the need for manual status updating on the part of the instructor. In addition, this system obviates the need for the instructor to receive emails from the foreign attorneys confirming that the various steps in the filing process have been completed, since he/she can simply look at the status of the case in the IP order database to see whether the case has been received/filed by the foreign agents in each country. This automatic status updating feature substantially reduces the workload of the instructor. Once they click the “send” button 30 in the instruction tool, they don't need to do any further work. Each of the foreign agents, by clicking one or more of the encoded URL's will automatically update the stages of the filing of their respective countries in the IP order database 1. The instructor need only check that all countries have been filed immediately before the deadline to ensure that all is in order. So in the background example of a filing into six countries, instead of the instructor exchanging 18 emails and updating the status 18 times, he/she only needs to click the “send button” 30 and the system takes care of the rest.

In an alternative embodiment, shown in FIG. 6, instead of the encoded URL automatically updating the status, the encoded URL 4 corresponds to a status update page 32 corresponding to the particular patent No and country pair. On that page the receiving agent is able to confirm the completion of various stages of the filing process. This embodiment is available in the event that additional security (such as password protection) is desired.

Turning to FIG. 7, there is disclosed a further embodiment of the present invention. As shown, the instruction email 3 includes the encoded URL 4 as previously discussed.

When the encoded URL 4 is activated it simulates, at a server 9, a web services request 10 (not shown). In response, the server produces a web services response 11 containing stage update information corresponding to:
(a) a particular order;
(b) a particular country; and
(c) a particular stage,
   and sends that web services response to an instructor docketing system 12 and a receiving agent docketing system 13. Preferably the web services response 11 is adapted to be processed by a webservices response processor (not shown) and takes the form of an XML file.

An example web services response 11 appears below:

<SOAP-ENV:Header/>

<SOAP-ENV:Body>

<ns2:WsOrderStatusResponse xmlns:ns2=“http://inovia.com /orderPlaced”>

<ns2:contact-id>contact@company.com</ns2:contact-id>

<ns2:patents>

<ns2:patent>

<ns2:biblio-data>

<ns2:patent-number>EP0501100</ns2:patent-number>
<ns2:title>Nonaqueous electrolyte secondary battery</ns2:title>
<ns2:applicant-name>Arcades Corporation</ns2:applicant-name>
<ns2:agent-name>Miller, John E.</ns2:agent-name>
<ns2:publication-language>English</ns2:publication-language>

</ns2:biblio-data>
<ns2:orders>

<ns2:order>

<ns2:id type=“Order”>a01Q0000003dkz2lAA</ns2:id>
<ns2:timestamp>04-Jul-2011 02:04:50</ns2:timestamp>
<ns2:documents>

<ns2:document type=“invoice”>
<ns2:description>Filing receipt for EP0501100</ns2:description>
<ns2:name>FILING_RECEIPT_EP0501100_pdf</ns2:name>
<ns2:url>http://inovia.s3.aws.com/
order%2F0014000034b5wDyAAl_00340002300mytgZAAQ.PDF</ns2:url>
<ns2:size>333.5 KB</ns2:size>
<ns2:created-timestamp>2011-02-13 10:46:44</ns2:created-timestamp>

</ns2:document>

</ns2:documents>
<ns2:status-items>

<ns2:status-item>

<ns2:name>Germany</ns2:name>
<ns2:code>DE</ns2:code>
<ns2:due-date>17-Jul-2011</ns2:due-date>
<ns2:status>Filed</ns2:status>
<ns2:last-updated-date>04-Jul-2011 02:04:51</ns2:last-updated-date>

</ns2:status-item>

</ns2:status-items>

</ns2:order>

</ns2:orders>

</ns2:patent>

</ns2:patents>

</ns2:WsOrderStatusResponse>

</SOAP-ENV:Body>

</SOAP-ENV:Envelope>

As will be understood by a person skilled in the art, the above WebServices response 11 corresponds to the validation in Germany of European patent number EP0501100 in the name of Arcades Corporation. This particular response 11 indicates that the status is “Filed.” Note that the order has an order identifier which is used to uniquely identify that order. In the present context, an order is a foreign patent filing into a selected set of countries. However, different unique identifiers for different intellectual property filings and steps are also envisaged.

When the instructor docketing system 12 and the receiving agent docketing systems 13 receives the web services response 11 they automatically update the stage 7 of the corresponding IP record 14, 14′ in their respective systems.

By way of example, if the instruction email 3 contained the first instruction to file an IP application, the receiving agent docketing system 13 would not include an IP record corresponding to that case. As such, when the receiving agent docketing system 13 received the web services response 11, it would:
(a) create an IP record 14′ corresponding to the IP order record 5;
(b) upload from the web services response any bibliographic information 15 (not shown) corresponding to the IP order record 5; and
(c) update the stage IP record 14′ to the equivalent of “received.”

In the same example, because the instructions originated from an instructor it is likely that the instructor docketing system 12 already contained an IP record 14 corresponding to the order record 5 and the country records 6. In that case, upon receipt of the web services response 11 the instructor docketing system 12 would only update the stage IP record 14 to the equivalent of “received.”

In this way, when a receiving agent clicks on the encoded URL, not only is the IP order database 1 updated, but also both the instructor docketing system 12 and the receiving agent docketing system 13 are also updated.

It can also be seen that the above WebServices protocol also allows for the association of a remotely stored document (in this example FILING_RECEIPT_EP0501100_pdf) with a particular order or stage. In the embodiment which allows a receiving agent to update a status on a status update page 32, that page also involves the ability to attach a document, such as a filing receipt or a copy of the translated specification. By storing that document securely and remotely and by providing a link to that document, the user can gain access to those documents without having to receive them via email.

In an alternative embodiment, rather than updating the instructor docketing system 12 “on the fly” the docketing system may instead be updated via a batch process. Such a batch process would include the provision of a bulk XML file including the updates status of any pending applications. The format would be similar to the format of the webservices response 11 described above, but between the <ns2:patents> tags a plurality of patents and their corresponding statuses would be provided.

In a preferred embodiment a docketing system could choose a variety of ways to have its status updated by sending a Webservices request that includes one or more of:

1. A single order status for a specific order; in which case, the request should contain the following fields:
a. Id
b. patent-number
c. contact-id

2. A bulk order status for a specific patent; in which case, the request should contain the following fields:
a. patent-number
b. contact-id

3. A bulk order status for a specific company/client; in which case, the request should contain the following field:
a. contact-id

It will be appreciated by those skilled in the art, that embodiments of this invention substantially reduce the email traffic going back from the receiving agents to the instructor, since the receiving agent simply needs to click on the encoded URL instead of sending an email to the instructor as each stage is performed.

Further, the duplicated effort of manually updating the status of the case in the instructor docketing system 12 and the receiving agent docketing system 13 is eliminated, as those systems are automatically updated by the webservices response 11. In addition, by instructing both the instruction process and the updating of statuses the present invention substantially reduces the possibility of human error in the instruction process.

The present invention may also be applied to the filing of other types of IP such as trade marks and registered designs. Similarly, the invention may be applied to other parts of the IP process, such as reporting an office action. In most countries the process of prosecuting a patent, trade mark or design involves a series of clearly defined steps (e.g. office action issues, response to office action, further office action issues etc). As such, when sending out an office action along with an encoded URL via the present invention's instruction tool, the receiving agent would simply click on the link and the status of the case would be updated automatically.

The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Although the invention has been described with reference to specific examples, it will be appreciated by those skilled in the art that the invention may be embodied in many other forms, including but not limited to being embodied as devices, systems and methods.

1. A computer system for instructing an intellectual property (IP) filing including an instruction tool adapted to communicate with an IP order database,
the IP order database being adapted to store a plurality of IP order records, each including:
(b) at least one receiving agent email address; and
(c) an updatable status,
the instruction tool being adapted to send an email containing a URL corresponding to a particular IP order record, to a corresponding receiving agent email address.

2. The computer system of claim 1 wherein when the encoded URL is activated the system updates the updatable status corresponding to the particular IP order record.

3. The computer system of claim 1 wherein the updatable status includes at least one of first, second, third and fourth stages.

4. The computer system off claim 3 wherein the first stage corresponds to “instructed”, the second stage corresponds to “received,” the third stage corresponds to “filed” and the fourth stage corresponds to “translation completed.”

5. The computer system of claim 1 wherein the URL is an encoded URL.

6. The computer system of claim 1 wherein, when activated, the URL provides access to website which allows a user to update the updatable status of the IP order record to a plurality of stages.

7. The computer system of claim 2 wherein upon activation of the URL the computer system automatically sends a confirmation email to the receiving agent email address.

8. (canceled)

9. A URL which, when activated, automatically modifies the status of an updatable status field of a particular IP order record stored in an IP order database.

10. The URL of claim 9 in encoded form.

11. (canceled)

12. An intellectual property docketing system including an IP order database and a web services response processor,
the IP order database being adapted to store a plurality of IP order records, each including an updatable status, and
the web services response processor being adapted to update the updatable status of at least one IP order record in response to receiving a web services response.

13. The docketing system of claim 13 wherein the web services response comprises an XML file including at least the following information:
(a) in IP order identifier; and
(b) a status update indicator.

14. The docketing system of claim 13 wherein the status update indicator is representative of a change in status from one stage to another of an IP order record corresponding to the IP order identifier.

15. The docketing system of claim 14 wherein the web services response processor is further adapted to create a new IP order record corresponding to the web services response in the IP order database.

16. (canceled)

17. A web services response comprising an XML file containing at least the following information:
(a) in IP order identifier; and
(b) a status update indicator.

18. (canceled)
